(19) United States
(12) Patent Application Publication
(10) Pub. No.: US 2022/0067762 A1
(43) Pub. Date: Mar. 3, 2022

(54) SYSTEM AND METHOD FOR PREDICTING AN OPTIMAL STOP POINT DURING AN EXPERIMENT TEST

(71) Applicant: Coupang Corp., Seoul (KR)

(72) Inventors: Xiaowei GONG, San Jose, CA (US); Beibei Ye, Fremont, CA (US); Jun Ye, Fremont, CA (US); Chul Seo, San Carlos, CA (US)

(73) Assignee: Coupang Corp., Seoul (KR)

(21) Appl. No.: 17/003,705

(22) Filed: Aug. 26, 2020

(51) Int. Cl. G06Q 30/02; G06F 17/18

(52) U.S. Cl. CPC G06Q 30/0204; G06F 17/18; G06Q 30/0201

(57) ABSTRACT

Computer-implemented systems and methods for predicting an optimal stop point during an experiment test are disclosed. A disclosed computer-implemented system comprises a memory storing instructions and at least one or more processors. The at least one or more processors may be configured to execute the instructions to obtain a total test time, obtain a minimum detectable effect trend data, determine an average minimum detectable effect change, determine a minimum detectable effect cumulative change threshold, determine a plurality of instantaneous minimum detectable effect changes, and determine a plurality of cumulative minimum detectable effect changes. Furthermore, the at least one or more processors may be configured to determine an optimal stop point time based on the average minimum detectable effect change, the plurality of instantaneous minimum detectable effect changes, and the minimum detectable effect cumulative change threshold to provide the optimal stop point time to a server to conclude the active test.

### TECHNICAL FIELD

The present disclosure generally relates to computerized systems and methods for determining when to stop a running experiment test. In particular, embodiments of the present disclosure relate to inventive and unconventional systems and methods for predicting an optimal stop point of the running experiment test.

### BACKGROUND

Currently design of experiments (DOEs) are utilized to understand the relationship between factors that affect a process and its outputs. DOEs are useful to understand the cause-and-effect relationships of various factors that one may be interested in. For example, many order fulfillment companies utilize DOEs to understand the behavioral patterns of their customer in order to maximize their profit. Specifically, order fulfillment companies may utilize A/B testing on their webpages to understand how their customers respond to changes of specific elements on their webpages. A/B testing may include preparing two versions of a webpage with variations in the forms and visual impressions of certain elements which may be utilized to measure the effects of those variations on sales. A/B testing may allow order fulfillment companies to construct hypotheses and learn why certain elements positively or negatively impact customers' behaviors. Understanding the reaction of customers may lead to a webpage design that maximizes profits by attracting customers who positively respond to the changes in the webpage.

However, while DOEs or A/B testing for webpages are useful, they require a lot of resources and time to run those experiments. DOEs or A/B testing may require long experiment test time to ensure that sufficient sample sizes relating to variations are included in the test data to provide statistically significant outcomes. For example, some experiment tests may last as long as six months to recover enough significant statistical data to make a proper decision on which variation has the most positive impact on customers. The variations having the most positive impact on customers may also be referred to as a winner in terms of some success metric. The success metric may be used to determine when to stop an experiment test where the variations of interest having the most positive impact on customers may reach a significant statistical improvement. The significant statistical improvement may be determined by comparing a P-value to a threshold value. The threshold value compared against the P-value to determine the significant statistical improvement may be 0.05, for example. If the P-value, for example, is less than the threshold value, the experiment test may be terminated since a significant statistical improvement in the variations of interest is reached or detected. On the other hand, if the P-value is greater than or equal to the threshold value, then the success metric has not reached or detected a significant statistical improvement to stop the experiment test. The success metric not reaching a significant statistical improvement may be due to an insufficient sample size related to the variations of interest to prevent the detection of the significant statistical improvement. The use of P-values alone by order fulfillment companies to make the determination that DOEs or A/B tests may be concluded may be ineffective in predicting the required amount of time to run DOEs or A/B tests. The ineffective prediction of time required to run the experiment test may translate to a lot of resources spent by the order fulfilment company.

Therefore, there is a need for improved methods and systems for predicting an optimal stop point during an experiment test.

### SUMMARY

One aspect of the present disclosure is directed to a computer-implemented system for predicting an optimal stop point during an experiment test. The computer-implemented system may comprise a memory storing instructions and at least one or more processors. The at least one or more processors may be configured to execute the instructions to obtain a total test time for an active design of experiment test on a server, obtain a minimum detectable effect trend data over the total test time for the active design of experiment test on the server, and determine an average minimum detectable effect change over the total test time associated with the minimum detectable effect trend data. Furthermore, the at least one or more processors may be configured to determine a minimum detectable effect cumulative change threshold over the total test time associated with the minimum detectable effect trend data, determine a plurality of instantaneous minimum detectable effect changes over the total test time associated with the minimum detectable effect trend data, and determine a plurality of cumulative minimum detectable effect changes associated with the plurality of instantaneous minimum detectable effect. Moreover, the at least one or more processors may be configured to determine an optimal stop point time based on the average minimum detectable effect change, the plurality of instantaneous minimum detectable effect changes, and the minimum detectable effect cumulative change threshold. The at least one or more processor may be configured to provide the optimal stop point time to the server for the active design of experiment test to conclude.

Another aspect of the present disclosure is directed to a method for predicting an optimal stop point during an experiment test. The method may comprise the steps of obtaining a total test time for an active design of experiment test on a server, obtaining a minimum detectable effect trend data over the total test time for the active design of experiment test on the server, and determining an average minimum detectable effect change over the total test time associated with the minimum detectable effect trend data. Furthermore, the method may comprise determining a minimum detectable effect cumulative change threshold over the total test time associated with the minimum detectable effect trend data, determining a plurality of instantaneous minimum detectable effect changes over the total test time associated with the minimum detectable effect trend data, and determining a plurality of cumulative minimum detectable effect changes associated with the plurality of instantaneous minimum detectable effect. Moreover, the method may comprise determining an optimal stop point time based on the average minimum detectable effect change, the plurality of instantaneous minimum detectable effect changes, and the minimum detectable effect cumulative change threshold. The method may comprise providing the optimal stop point time to the server for the active design of experiment test to conclude.

Yet another aspect of the present disclosure is directed to a computer-implemented system for predicting an optimal stop point during an experiment test. The computer-implemented system may comprise a memory storing instructions and at least one or more processors. The at least one or more processors may be configured to execute the instructions to obtain a total test time for an active design of experiment test on a server, obtain a minimum detectable effect trend data over the total test time for the active design of experiment test on the server, and determine an average minimum detectable effect change over the total test time associated with the minimum detectable effect trend data. Furthermore, the at least one or more processors may be configured to determine a minimum detectable effect cumulative change threshold over the total test time associated with the minimum detectable effect trend data, determine a plurality of instantaneous minimum detectable effect changes over the total test time associated with the minimum detectable effect trend data, and determine a plurality of cumulative minimum detectable effect changes associated with the plurality of instantaneous minimum detectable effect. Moreover, the at least one or more processors may be configured to determine an optimal stop point time when an instantaneous minimum detectable effect change associated with the optimal stop point time from the database may be less than the average minimum detectable effect change, and a cumulative detectable effect change associated with the optimal stop point time from the database may be greater than the minimum detectable effect cumulative change threshold. The at least one or more processor may be configured to provide the optimal stop point time to the server for the active design of experiment test to conclude.

Other systems, methods, and computer-readable media are also discussed herein.

### BRIEF DESCRIPTION OF THE DRAWINGS

FIG. 1A is a schematic block diagram illustrating an exemplary embodiment of a network comprising computerized systems for communications enabling shipping, transportation, and logistics operations, consistent with the disclosed embodiments.

FIG. 1B depicts a sample Search Result Page (SRP) that includes one or more search results satisfying a search request along with interactive user interface elements, consistent with the disclosed embodiments.

FIG. 1C depicts a sample Single Display Page (SDP) that includes a product and information about the product along with interactive user interface elements, consistent with the disclosed embodiments.

FIG. 1D depicts a sample Cart page that includes items in a virtual shopping cart along with interactive user interlace elements, consistent with the disclosed embodiments.

FIG. 1E depicts a sample Order page that includes items from the virtual shopping cart along with information regarding purchase and shipping, along with interactive user interface elements, consistent with the disclosed embodiments.

FIG. 2 is a diagrammatic illustration of an exemplary fulfillment center configured to utilize disclosed computerized systems, consistent with the disclosed embodiments.

FIG. 3 is a block diagram illustrating an exemplary system for predicting an optimal stop point during an experiment test, consistent with the disclosed embodiments.

FIG. 4 depicts a sample minimum detectable effect trend data curve and an average minimum detectable effect change, consistent with the disclosed embodiments.

FIG. 5 is a flow chart of an exemplary method of determining an optimal stop point time, consistent with the disclosed embodiments.

FIG. 6 is a flow chart of an exemplary method of determining a plurality of instantaneous minimum detectable effect changes, consistent with the disclosed embodiments.

FIG. 7 is a flow chart of an exemplary method of determining a plurality of cumulative minimum detectable effect changes, consistent with the disclosed embodiments.

FIG. 8 is a flow chart of an exemplary method of determining and providing an optimal stop point time to a server to stop an active A/13 test or design of experiment test, consistent with the disclosed embodiments.

FIG. 9 depicts samples optimal stop time determination conditions, consistent with the disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components and steps illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope of the invention is defined by the appended claims.

Embodiments of the present disclosure are directed to systems and methods configured to specifically predict the optimal stop point time of an active A/B test or design of experiment test being conducted on a webpage. The optimal stop point time may be used to conclude or terminate an active A/B test or design of experiment test to prevent a website operator (e.g., an online order fulfillment company) from spending any additional capital resources in further conducting the active A/B test or design of experiment test. The optimal stop point time may be determined from the active A/B test or design of experiment test with the use of a minimal detectable effect (MDE). Current MDE values or data (also known as an observed MDE data) may be calculated from the active A/B test or design of experiment test's collected data for the variations of interest thus far. The collected data for the variations of interest thus far may be changes in features between the baseline webpage and variations of the baseline webpage of the order fulfillment company. The current MDE data may show that the active A/B test or design of experiment test may be powerful enough to detect minimum effect size in the collected data for the variations of interest thus far. Furthermore, future or predicted MDE data may also be determined from the collected data for the variations of interest in the active A/B test or design of experiment test if the active A/B test or design of experiment test is ran for a longer time. MDE trend data may include both the observed MDE data and the future or predicted MDE data from the active A/B test or design of experiment test. Therefore, the MDE trend data may be used to determine whether to continue or stop the active A/B test or design of experiment test. For example, if the order fulfillment company decides that the observed MDE data or MDE trend data should be no more than, for example, 5%, and the observed MDE data is higher than 5%, but the future or predicted MDE data trend shows the chance of going below 5% soon, then the order fulfillment company may decide that it may be worth continuing the active A/B test or design of experiment test until the observed MDE data or MDE trend data may be less or equal to 5%. When the observed MDE data or MDE trend data may be less or equal to 5%, then the order fulfillment company may terminate the active A/B test or design of experiment test. Or if the future or predicted MDE data trend shows no chance of going below 5% in a reasonable future time, then the order fulfillment company may decide to terminate the test now.

In another embodiment, if the order fulfillment company decides that the MDE trend data should be no more than, for example, 5%, and the MDE trend data is higher than 5%, but the MDE trend data shows the chance of going below 5% soon, then the order fulfillment company may decide that it may be worth continuing the active A/B test or design of experiment test until the MDE trend data may be less or equal to 5%. When the MDE trend data may be less or equal to 5%, then the order fulfillment company may terminate the active A/B test or design of experiment test. Or if the MDE trend data trend shows no chance of going below 5% in a reasonable future time, then the order fulfillment company may decide to terminate the test now.

In another embodiment, if the order fulfillment company decides that the current MDE values or data should be no more than, for example, 5%, and the current MDE values or data is higher than 5%, but the current MDE values or data trend shows the chance of going below 5% soon, then the order fulfillment company may decide that it may be worth continuing the active A/B test or design of experiment test until the current MDE values or data may be less or equal to 5%. When the current MDE values or data may be less or equal to 5%, then the order fulfillment company may terminate the active A/B test or design of experiment test. Or if the current MDE values or data trend shows no chance of going below 5% in a reasonable future time, then the order fulfillment company may decide to terminate the test now.

In yet another embodiment, if the order fulfillment company decides that the observed MDE data should be no more than, for example, 5%, and the observed MDE data is higher than 5%, but the MDE trend data shows the chance of going below 5% soon, then the order fulfillment company may decide that it may be worth continuing the active A/B test or design of experiment test until the observed MDE data may be less or equal to 5%. When the MDE trend data may be less or equal to 5%, then the order fulfillment company may terminate the active A/B test or design of experiment test. Or if the MDE trend data shows no chance of going below 5% in a reasonable future time, then the order fulfillment company may decide to terminate the test now.

In another embodiment, if the order fulfillment company decides that the observed MDE data should be no more than, for example, 5%, and the observed MDE data is higher than 5%, but the observed MDE data trend shows the chance of going below 5% soon, then the order fulfillment company may decide that it may be worth continuing the active A/B test or design of experiment test until the observed MDE data may be less or equal to 5%. When the observed MDE data may be less or equal to 5%, then the order fulfillment company may terminate the active A/B test or design of experiment test. Or if the observed MDE data trend shows no chance of going below 5% in a reasonable future time, then the order fulfillment company may decide to terminate the test now.

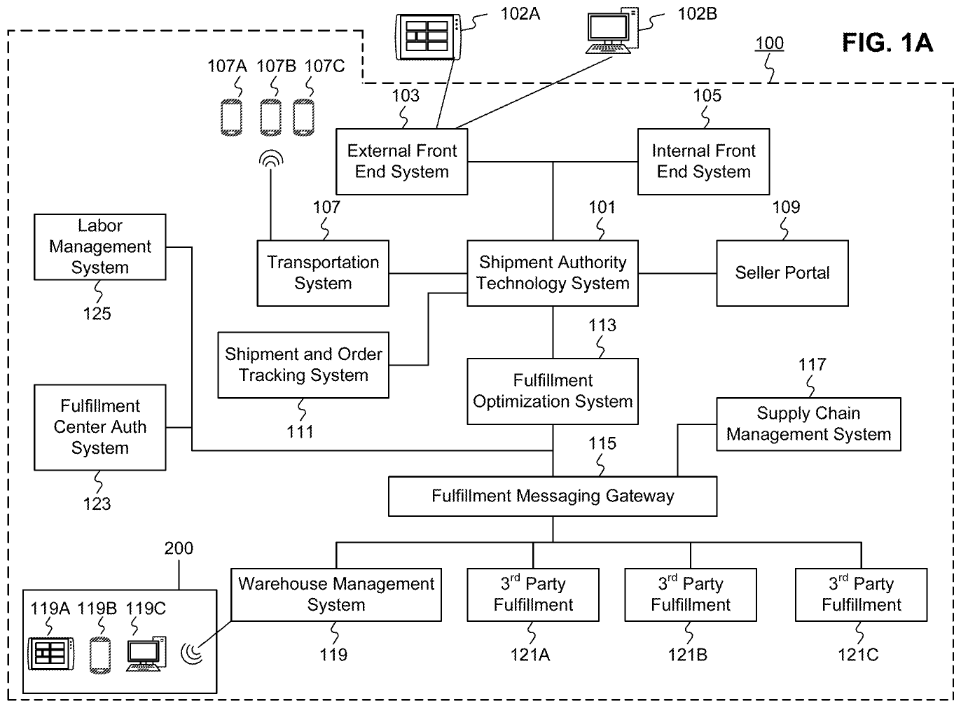

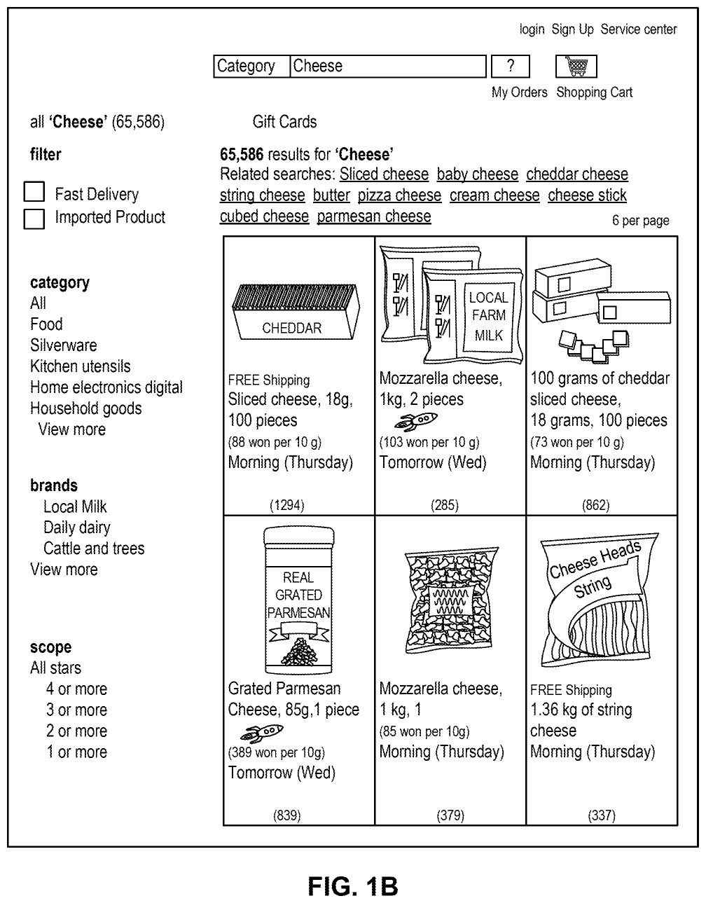

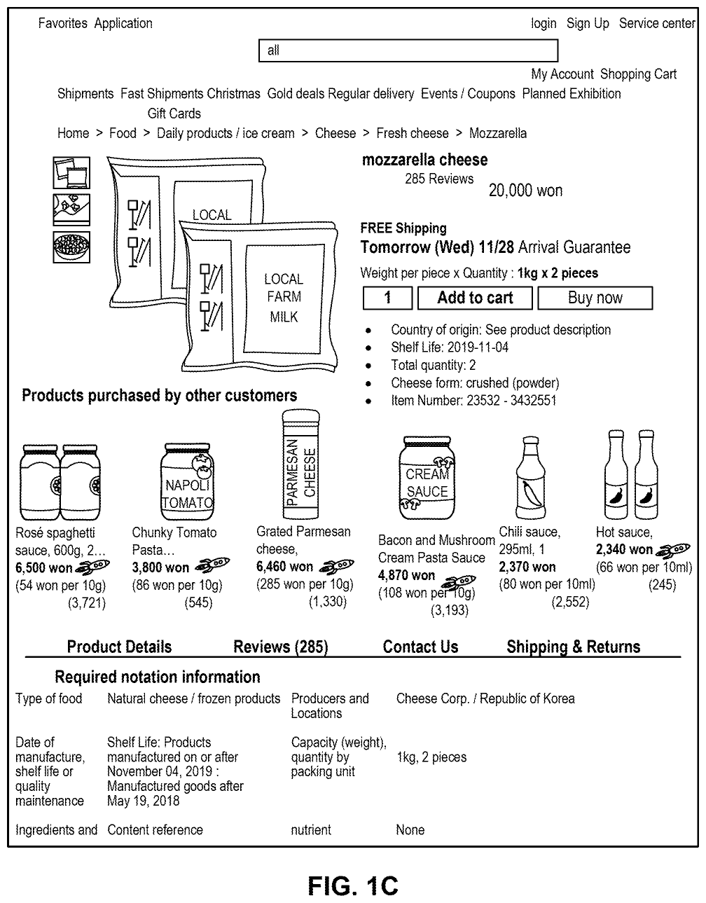

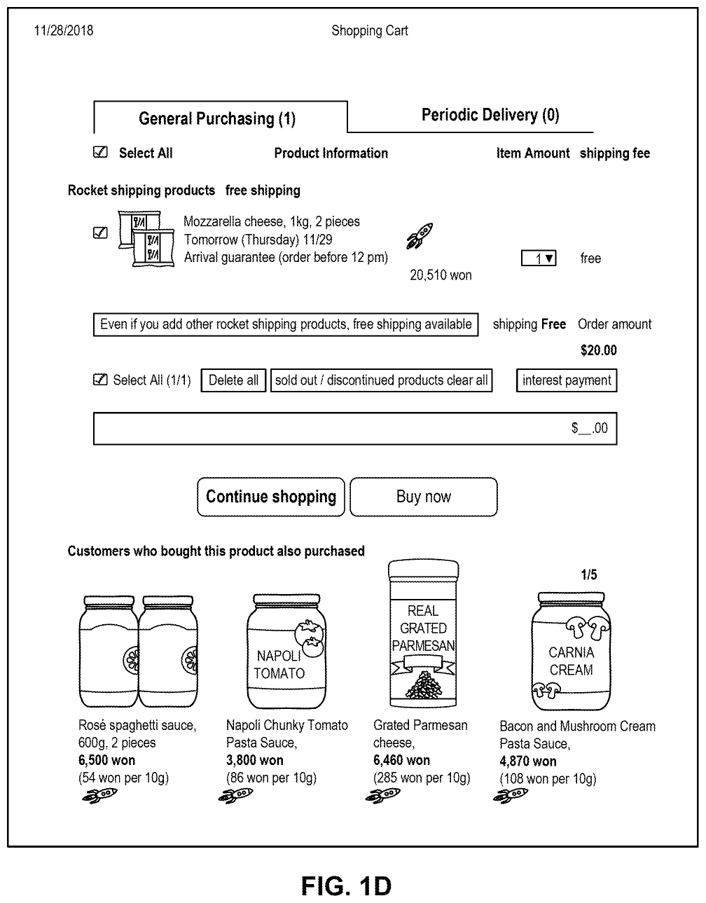

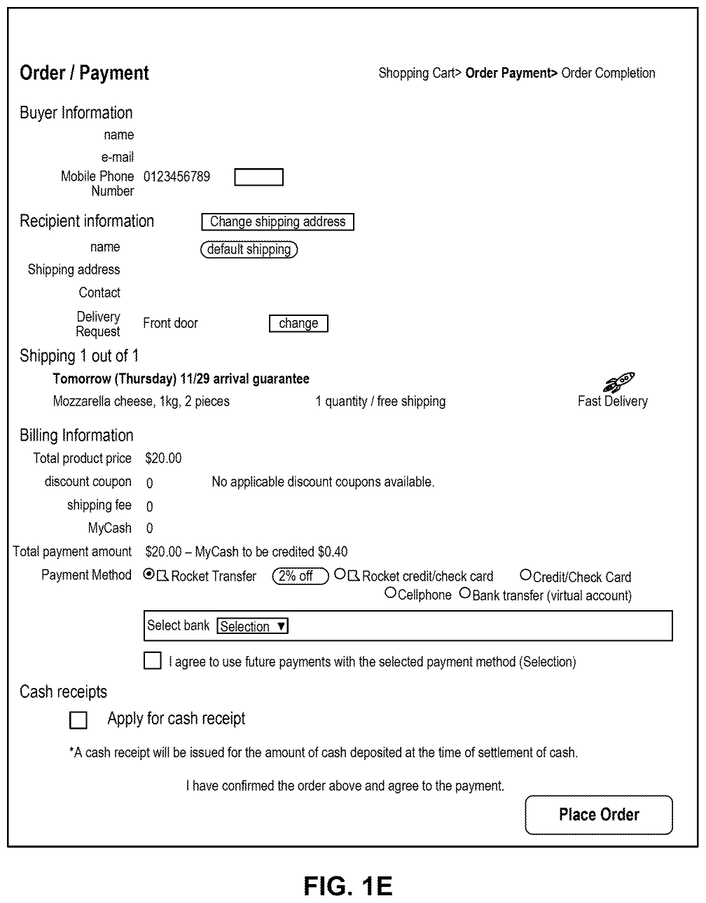

Referring to FIG. 1A, a schematic block diagram 100 illustrating an exemplary embodiment of a system comprising computerized systems for communications enabling shipping, transportation, and logistics operations is shown. As illustrated in FIG. 1A, system 100 may include a variety of systems, each of which may be connected to one another via one or more networks. The systems may also be connected to one another via a direct connection, for example, using a cable. The depicted systems include a shipment authority technology (SAT) system 101, an external front end system 103, an internal front end system 105, a transportation system 107, mobile devices 107A, 107B, and 107C, seller portal 109, shipment and order tracking (SOT) system 111, fulfillment optimization (FO) system 113, fulfillment messaging gateway (FMG) 115, supply chain management (SCM) system 117, warehouse management system 119, mobile devices 119A, 119B, and 119C (depicted as being inside of fulfillment center (FC) 200), 3^{rd} party fulfillment systems 121A, 121B, and 121C, fulfillment center authorization system (FC Auth) 123, and labor management system (LMS) 125.

SAT system 101, in some embodiments, may be implemented as a computer system that monitors order status and delivery status. For example, SAT system 101 may determine whether an order is past its Promised Delivery Date (PDD) and may take appropriate action, including initiating a new order, reshipping the items in the non-delivered order, canceling the non-delivered order, initiating contact with the ordering customer, or the like. SAT system 101 may also monitor other data, including output (such as a number of packages shipped during a particular time period) and input (such as the number of empty cardboard boxes received for use in shipping). SAT system 101 may also act as a gateway between different devices in system 100, enabling communication (e.g., using store-and-forward or other techniques) between devices such as external front end system 103 and FO system 113.

External front end system 103, in some embodiments, may be implemented as a computer system that enables external users to interact with one or more systems in system 100. For example, in embodiments where system 100 enables the presentation of systems to enable users to place an order for an item, external front end system 103 may be implemented as a web server that receives search requests, presents item pages, and solicits payment information. For example, external front end system 103 may be implemented as a computer or computers running software such as the Apache HTTP Server, Microsoft Internet Information Services (IIS), NGINX, or the like. In other embodiments, external front end system 103 may run custom web server software designed to receive and process requests from external devices (e.g., mobile device 102A or computer 102B), acquire information from databases and other data stores based on those requests, and provide responses to the received requests based on acquired information.

In some embodiments, external front end system 103 may include one or more of a web caching system, a database, a search system, or a payment system. In one aspect, external front end system 103 may comprise one or more of these systems, while in another aspect, external front end system 103 may comprise interfaces (e.g., server-to-server, database-to-database, or other network connections) connected to one or more of these systems.

An illustrative set of steps, illustrated by FIGS. 1B, 1C, 1D, and 1E, will help to describe some operations of external front end system 103. External front end system 103 may receive information from systems or devices in system 100 for presentation and/or display. For example, external front end system 103 may host or provide one or more web pages, including a Search Result Page (SRP) (e.g., FIG. 1B), a Single Detail Page (SDP) (e.g., FIG. 1C), a Cart page (e.g., FIG. 1D), or an Order page (e.g., FIG. 1E). A user device (e.g., using mobile device 102A or computer 102B) may navigate to external front end system 103 and request a search by entering information into a search box. External front end system 103 may request information from one or more systems in system 100. For example, external front end system 103 may request information from FO System 113 that satisfies the search request. External front end system 103 may also request and receive (from FO System 113) a Promised Delivery Date or “PDD” for each product included in the search results. The PDD, in some embodiments, may represent an estimate of when a package containing the product will arrive at the user's desired location or a date by which the product is promised to be delivered at the user's desired location if ordered within a particular period of time, for example, by the end of the day (11:59 PM). (PDD is discussed further below with respect to FO System 113.)

External front end system 103 may prepare an SRP (e.g., FIG. 1B) based on the information. The SRP may include information that satisfies the search request. For example, this may include pictures of products that satisfy the search request. The SRP may also include respective prices for each product, or information relating to enhanced delivery options for each product, PDD, weight, size, offers, discounts, or the like. External front end system 103 may send the SRP to the requesting user device (e.g., via a network).

A user device may then select a product from the SRP, e.g., by clicking or tapping a user interface, or using another input device, to select a product represented on the SRP. The user device may formulate a request for information on the selected product and send it to external front end system 103. In response, external front end system 103 may request information related to the selected product. For example, the information may include additional information beyond that presented for a product on the respective SRP. This could include, for example, shelf life, country of origin, weight, size, number of items in package, handling instructions, or other information about the product. The information could also include recommendations for similar products (based on, for example, big data and/or machine learning analysis of customers who bought this product and at least one other product), answers to frequently asked questions, reviews from customers, manufacturer information, pictures, or the like.

External front end system 103 may prepare an SDP (Single Detail Page) (e.g., FIG. 1C) based on the received product information. The SDP may also include other interactive elements such as a “Buy Now” button, a “Add to Cart” button, a quantity field , a picture of the item, or the like. The SDP may further include a list of sellers that offer the product. The list may be ordered based on the price each seller offers such that the seller that offers to sell the product at the lowest price may be listed at the top. The list may also be ordered based on the seller ranking such that the highest ranked seller may be listed at the top. The seller ranking may be formulated based on multiple factors, including, for example, the seller's past track record of meeting a promised PDD. External front end system 103 may deliver the SDP to the requesting user device (e.g., via a network).

The requesting user device may receive the SDP which lists the product information. Upon receiving the SDP, the user device may then interact with the SDP. For example, a user of the requesting user device may click or otherwise interact with a “Place in Cart” button on the SDP. This adds the product to a shopping cart associated with the user. The user device may transmit this request to add the product to the shopping cart to external front end system 103.

External front end system 103 may generate a Cart page (e.g., FIG. 1D). The Cart page, in some embodiments, lists the products that the user has added to a virtual “shopping cart.” A user device may request the Cart page by clicking on or otherwise interacting with an icon on the SRP, SDP, or other pages. The Cart page may, in some embodiments, list all products that the user has added to the shopping cart, as well as information about the products in the cart such as a quantity of each product, a price for each product per item, a price for each product based on an associated quantity, information regarding PDD, a delivery method, a shipping cost, user interface elements for modifying the products in the shopping cart (e.g., deletion or modification of a quantity), options for ordering other product or setting up periodic delivery of products, options for setting up interest payments, user interface elements for proceeding to purchase, or the like. A user at a user device may click on or otherwise interact with a user interface element (e.g., a button that reads “Buy Now”) to initiate the purchase of the product in the shopping cart. Upon doing so, the user device may transmit this request to initiate the purchase to external front end system 103.

External front end system 103 may generate an Order page (e.g., FIG. 1E) in response to receiving the request to initiate a purchase. The Order page, in some embodiments, re-lists the items from the shopping cart and requests input of payment and shipping information. For example, the Order page may include a section requesting information about the purchaser of the items in the shopping cart (e.g., name, address, e-mail address, phone number), information about the recipient (e.g., name, address, phone number, delivery information), shipping information (e.g., speed/method of delivery and/or pickup), payment information (e.g., credit card, bank transfer, check, stored credit), user interface elements to request a cash receipt (e.g., for tax purposes), or the like. External front end system 103 may send the Order page to the user device.

The user device may enter information on the Order page and click or otherwise interact with a user interface element that sends the information to external front end system 103. From there, external front end system 103 may send the information to different systems in system 100 to enable the creation and processing of a new order with the products in the shopping cart.

In some embodiments, external front end system 103 may be further configured to enable sellers to transmit and receive information relating to orders.

Internal front end system 105, in some embodiments, may be implemented as a computer system that enables internal users (e.g., employees of an organization that owns, operates, or leases system 100) to interact with one or more systems in system 100. For example, in embodiments where system 100 enables the presentation of systems to enable users to place an order for an item, internal front end system 105 may be implemented as a web server that enables internal users to view diagnostic and statistical information about orders, modify item information, or review statistics relating to orders. For example, internal front end system 105 may be implemented as a computer or computers running software such as the Apache HTTP Server, Microsoft Internet Information Services (IIS), NGINX, or the like. In other embodiments, internal front end system 105 may run custom web server software designed to receive and process requests from systems or devices depicted in system 100 (as well as other devices not depicted), acquire information from databases and other data stores based on those requests, and provide responses to the received requests based on acquired information.

In some embodiments, internal front end system 105 may include one or more of a web caching system, a database, a search system, a payment system, an analytics system, an order monitoring system, or the like. In one aspect, internal front end system 105 may comprise one or more of these systems, while in another aspect, internal front end system 105 may comprise interfaces (e.g., server-to-server, database-to-database, or other network connections) connected to one or more of these systems.

Transportation system 107, in some embodiments, may be implemented as a computer system that enables communication between systems or devices in system 100 and mobile devices 107A-107C. Transportation system 107, in some embodiments, may receive information from one or more mobile devices 107A-107C (e.g., mobile phones, smart phones, PDAs, or the like). For example, in some embodiments, mobile devices 107A-107C may comprise devices operated by delivery workers. The delivery workers, who may be permanent, temporary, or shift employees, may utilize mobile devices 107A-107C to effect delivery of packages containing the products ordered by users. For example, to deliver a package, the delivery worker may receive a notification on a mobile device indicating which package to deliver and where to deliver it. Upon arriving at the delivery location, the delivery worker may locate the package (e.g., in the back of a truck or in a crate of packages), scan or otherwise capture data associated with an identifier on the package (e.g., a barcode, an image, a text string, an RFID tag, or the like) using the mobile device, and deliver the package (e.g., by leaving it at a front door, leaving it with a security guard, handing it to the recipient, or the like). In some embodiments, the delivery worker may capture photo(s) of the package and/or may obtain a signature using the mobile device. The mobile device may send information to transportation system 107 including information about the delivery, including, for example, time, date, GPS location, photo(s), an identifier associated with the delivery worker, an identifier associated with the mobile device, or the like. Transportation system 107 may store this information in a database (not pictured) for access by other systems in system 100. Transportation system 107 may, in some embodiments, use this information to prepare and send tracking data to other systems indicating the location of a particular package.

In some embodiments, certain users may use one kind of mobile device (e.g., permanent workers may use a specialized PDA with custom hardware such as a barcode scanner, stylus, and other devices) while other users may use other kinds of mobile devices (e.g., temporary or shift workers may utilize off-the-shelf mobile phones and/or smartphones).

In some embodiments, transportation system 107 may associate a user with each device. For example, transportation system 107 may store an association between a user (represented by, e.g., a user identifier, an employee identifier, or a phone number) and a mobile device (represented by, e.g., an International Mobile Equipment Identity (IMEI), an International Mobile Subscription Identifier (IMSI), a phone number, a Universal Unique Identifier (UUID), or a Globally Unique Identifier (GUID)). Transportation system 107 may use this association in conjunction with data received on deliveries to analyze data stored in the database in order to determine, among other things, a location of the worker, an efficiency of the worker, or a speed of the worker.

Seller portal 109, in some embodiments, may be implemented as a computer system that enables sellers or other external entities to electronically communicate with one or more systems in system 100. For example, a seller may utilize a computer system (not pictured) to upload or provide product information, order information, contact information, or the like, for products that the seller wishes to sell through system 100 using seller portal 109.

Shipment and order tracking system 111, in some embodiments, may be implemented as a computer system that receives, stores, and forwards information regarding the location of packages containing products ordered by customers (e.g., by a user using devices 102A-102B). In some embodiments, shipment and order tracking system 111 may request or store information from web servers (not pictured) operated by shipping companies that deliver packages containing products ordered by customers.

In some embodiments, shipment and order tracking system 111 may request and store information from systems depicted in system 100. For example, shipment and order tracking system 111 may request information from transportation system 107. As discussed above, transportation system 107 may receive information from one or more mobile devices 107A-107C (e.g., mobile phones, smart phones, PDAs, or the like) that are associated with one or more of a user (e.g., a delivery worker) or a vehicle (e.g., a delivery truck). In some embodiments, shipment and order tracking system 111 may also request information from warehouse management system (WMS) 119 to determine the location of individual products inside of a fulfillment center (e.g., fulfillment center 200). Shipment and order tracking system 111 may request data from one or more of transportation system 107 or WMS 119, process it, and present it to a device (e.g., user devices 102A and 102B) upon request.

Fulfillment optimization (FO) system 113, in some embodiments, may be implemented as a computer system that stores information for customer orders from other systems (e.g., external front end system 103 and/or shipment and order tracking system 111). FO system 113 may also store information describing where particular items are held or stored. For example, certain items may be stored only in one fulfillment center, while certain other items may be stored in multiple fulfillment centers. In still other embodiments, certain fulfilment centers may be designed to store only a particular set of items (e.g., fresh produce or frozen products). FO system 113 stores this information as well as associated information (e.g., quantity, size, date of receipt, expiration date, etc.).

FO system 113 may also calculate a corresponding PDD (promised delivery date) for each product. The PDD, in some embodiments, may be based on one or more factors. For example, FO system 113 may calculate a PDD for a product based on a past demand for a product (e.g., how many times that product was ordered during a period of time), an expected demand for a product (e.g., how many customers are forecast to order the product during an upcoming period of time), a network-wide past demand indicating how many products were ordered during a period of time, a network-wide expected demand indicating how many products are expected to be ordered during an upcoming period of time, one or more counts of the product stored in each fulfillment center 200, which fulfillment center stores each product, expected or current orders for that product, or the like.

In some embodiments, FO system 113 may determine a PDD for each product on a periodic basis (e.g., hourly) and store it in a database for retrieval or sending to other systems (e.g., external front end system 103, SAT system 101, shipment and order tracking system 111). In other embodiments, FO system 113 may receive electronic requests from one or more systems (e.g., external front end system 103, SAT system 101, shipment and order tracking system 111) and calculate the PDD on demand.

Fulfilment messaging gateway (FMG) 115, in some embodiments, may be implemented as a computer system that receives a request or response in one format or protocol from one or more systems in system 100, such as FO system 113, converts it to another format or protocol, and forward it in the converted format or protocol to other systems, such as WMS 119 or 3^{rd} party fulfillment systems 121A, 121B, or 121C, and vice versa.

Supply chain management (SCM) system 117, in some embodiments, may be implemented as a computer system that performs forecasting functions. For example, SCM system 117 may forecast a level of demand for a particular product based on, for example, based on a past demand for products, an expected demand for a product, a network-wide past demand, a network-wide expected demand, a count products stored in each fulfillment center 200, expected or current orders for each product, or the like. In response to this forecasted level and the amount of each product across all fulfillment centers, SCM system 117 may generate one or more purchase orders to purchase and stock a sufficient quantity to satisfy the forecasted demand for a particular product.

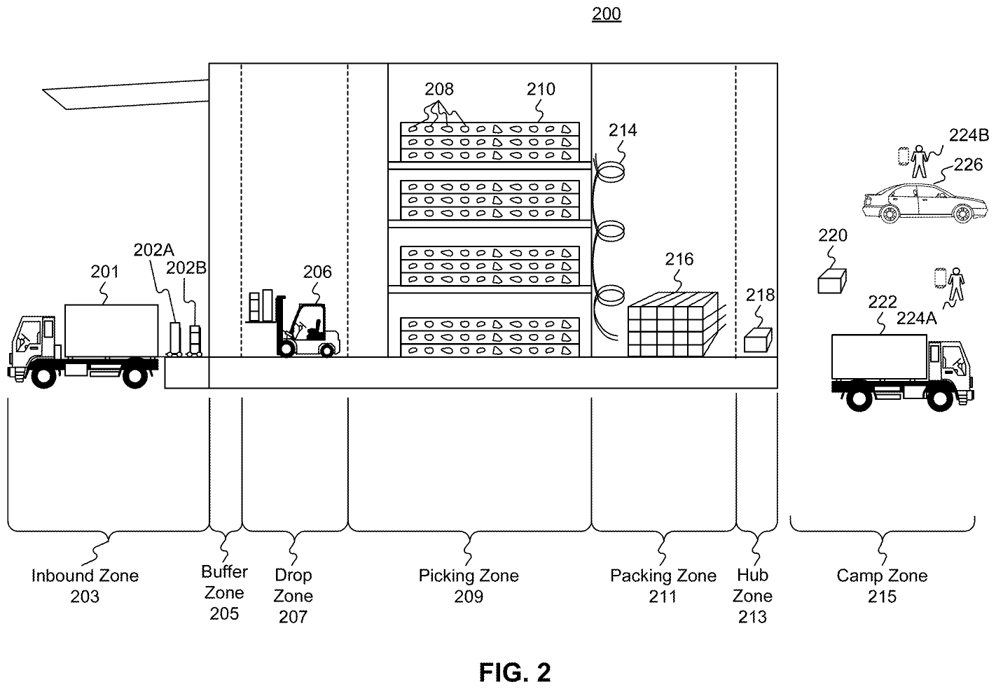

Warehouse management system (WMS) 119, in some embodiments, may be implemented as a computer system that monitors workflow. For example, WMS 119 may receive event data from individual devices (e.g., devices 107A-1070 or 119A-119C) indicating discrete events. For example, WMS 119 may receive event data indicating the use of one of these devices to scan a package. As discussed below with respect to fulfillment center 200 and FIG. 2, during the fulfillment process, a package identifier (e.g., a barcode or RFID tag data) may be scanned or read by machines at particular stages (e.g., automated or handheld barcode scanners, RFID readers, high-speed cameras, devices such as tablet 119A, mobile device/PDA 1198, computer 119C, or the like). WMS 119 may store each event indicating a scan or a read of a package identifier in a corresponding database (not pictured) along with the package identifier, a time, date, location, user identifier, or other information, and may provide this information to other systems (e.g., shipment and order tracking system 111).

WMS 119, in some embodiments, may store information associating one or more devices (e.g., devices 107A-107C or 119A-119C) with one or more users associated with system 100. For example, in some situations, a user (such as a part- or full-time employee) may be associated with a mobile device in that the user owns the mobile device (e.g., the mobile device is a smartphone). In other situations, a user may be associated with a mobile device in that the user is temporarily in custody of the mobile device (e.g., the user checked the mobile device out at the start of the day, will use it during the day, and will return it at the end of the day).

WMS 119, in some embodiments, may maintain a work log for each user associated with system 100. For example, WMS 119 may store information associated with each employee, including any assigned processes (e.g., unloading trucks, picking items from a pick zone, rebin wall work, packing items), a user identifier, a location (e.g., a floor or zone in a fulfillment center 200), a number of units moved through the system by the employee (e.g., number of items picked, number of items packed), an identifier associated with a device (e.g., devices 119A-119C), or the like. In some embodiments, WMS 119 may receive check-in and check-out information from a timekeeping system, such as a timekeeping system operated on a device 119A-119C.

3^{rd} party fulfillment (3PL) systems 121A-121C, in some embodiments, represent computer systems associated with third-party providers of logistics and products. For example, while some products are stored in fulfillment center 200 (as discussed below with respect to FIG. 2), other products may be stored off-site, may be produced on demand, or may be otherwise unavailable for storage in fulfillment center 200. 3PL systems 121A-121C may be configured to receive orders from FO system 113 (e.g., through FMG 115) and may provide products and/or services (e.g., delivery or installation) to customers directly. In some embodiments, one or more of 3PL systems 121A-121C may be part of system 100, while in other embodiments, one or more of 3PL systems 121A-121C may be outside of system 100 (e.g., owned or operated by a third-party provider).

Fulfillment Center Auth system (FC Auth) 123, in some embodiments, may be implemented as a computer system with a variety of functions. For example, in some embodiments, FC Auth 123 may act as a single-sign on (SSO) service for one or more other systems in system 100. For example, FC Auth 123 may enable a user to log in via internal front end system 105, determine that the user has similar privileges to access resources at shipment and order tracking system 111, and enable the user to access those privileges without requiring a second log in process. FC Auth 123, in other embodiments, may enable users (e.g., employees) to associate themselves with a particular task. For example, some employees may not have an electronic device (such as devices 119A-119C) and may instead move from task to task, and zone to zone, within a fulfillment center 200, during the course of a day. FC Auth 123 may be configured to enable those employees to indicate what task they are performing and what zone they are in at different times of day.

Labor management system (LMS) 125, in some embodiments, may be implemented as a computer system that stores attendance and overtime information for employees (including full-time and part-time employees). For example, LMS 125 may receive information from FC Auth 123, WMS 119, devices 119A-119C, transportation system 107, and/or devices 107A-107C.

The particular configuration depicted in FIG. 1A is an example only. For example, while FIG. 1A depicts FC Auth system 123 connected to FO system 113, not all embodiments require this particular configuration. Indeed, in some embodiments, the systems in system 100 may be connected to one another through one or more public or private networks, including the Internet, an Intranet, a WAN (Wide-Area Network), a MAN (Metropolitan-Area Network), a wireless network compliant with the IEEE 802.11a/b/g/n Standards, a leased line, or the like. In some embodiments, one or more of the systems in system 100 may be implemented as one or more virtual servers implemented at a data center, server farm, or the like.

FIG. 2 depicts a fulfillment center 200. Fulfillment center 200 is an example of a physical location that stores items for shipping to customers when ordered. Fulfillment center (FC) 200 may be divided into multiple zones, each of which are depicted in FIG. 2. These “zones,” in some embodiments, may be thought of as virtual divisions between different stages of a process of receiving items, storing the items, retrieving the items, and shipping the items. So while the “zones” are depicted in FIG. 2, other divisions of zones are possible, and the zones in FIG. 2 may be omitted, duplicated, or modified in some embodiments.

Inbound zone 203 represents an area of FC 200 where items are received from sellers who wish to sell products using system 100 from FIG. 1A. For example, a seller may deliver items 202A and 202B using truck 201. Item 202A may represent a single item large enough to occupy its own shipping pallet, while item 202B may represent a set of items that are stacked together on the same pallet to save space.

A worker will receive the items in inbound zone 203 and may optionally check the items for damage and correctness using a computer system (not pictured). For example, the worker may use a computer system to compare the quantity of items 202A and 202B to an ordered quantity of items. If the quantity does not match, that worker may refuse one or more of items 202A or 202B. If the quantity does match, the worker may move those items (using, e.g., a dolly, a handtruck, a forklift, or manually) to buffer zone 205. Buffer zone 205 may be a temporary storage area for items that are not currently needed in the picking zone, for example, because there is a high enough quantity of that item in the picking zone to satisfy forecasted demand. In some embodiments, forklifts 206 operate to move items around buffer zone 205 and between inbound zone 203 and drop zone 207. If there is a need for items 202A or 202B in the picking zone (e.g., because of forecasted demand), a forklift may move items 202A or 202B to drop zone 207.

Drop zone 207 may be an area of FC 200 that stores items before they are moved to picking zone 209. A worker assigned to the picking task (a “picker”) may approach items 202A and 202B in the picking zone, scan a barcode for the picking zone, and scan barcodes associated with items 202A and 202B using a mobile device (e.g., device 119B). The picker may then take the item to picking zone 209 (e.g., by placing it on a cart or carrying it).

Picking zone 209 may be an area of FC 200 where items 208 are stored on storage units 210. In some embodiments, storage units 210 may comprise one or more of physical shelving, bookshelves, boxes, totes, refrigerators, freezers, cold stores, or the like. In some embodiments, picking zone 209 may be organized into multiple floors. In some embodiments, workers or machines may move items into picking zone 209 in multiple ways, including, for example, a forklift, an elevator, a conveyor belt, a cart, a handtruck, a dolly, an automated robot or device, or manually. For example, a picker may place items 202A and 202B on a handtruck or cart in drop zone 207 and walk items 202A and 202B to picking zone 209.

A picker may receive an instruction to place (or “stow”) the items in particular spots in picking zone 209, such as a particular space on a storage unit 210. For example, a picker may scan item 202A using a mobile device (e.g., device 119B). The device may indicate where the picker should stow item 202A, for example, using a system that indicate an aisle, shelf, and location. The device may then prompt the picker to scan a barcode at that location before stowing item 202A in that location. The device may send (e.g., via a wireless network) data to a computer system such as WMS 119 in FIG. 1A indicating that item 202A has been stowed at the location by the user using device 119B.

Once a user places an order, a picker may receive an instruction on device 119B to retrieve one or more items 208 from storage unit 210. The picker may retrieve item 208, scan a barcode on item 208, and place it on transport mechanism 214. While transport mechanism 214 is represented as a slide, in some embodiments, transport mechanism may be implemented as one or more of a conveyor belt, an elevator, a cart, a forklift, a handtruck, a dolly, a cart, or the like. Item 208 may then arrive at packing zone 211.

Packing zone 211 may be an area of FC 200 where items are received from picking zone 209 and packed into boxes or bags for eventual shipping to customers. In packing zone 211, a worker assigned to receiving items (a “rebin worker”) will receive item 208 from picking zone 209 and determine what order it corresponds to. For example, the rebin worker may use a device, such as computer 119C, to scan a barcode on item 208. Computer 119C may indicate visually which order item 208 is associated with. This may include, for example, a space or “cell” on a wall 216 that corresponds to an order. Once the order is complete (e.g., because the cell contains all items for the order), the rebin worker may indicate to a packing worker (or “packer”) that the order is complete. The packer may retrieve the items from the cell and place them in a box or bag for shipping. The packer may then send the box or bag to a hub zone 213, e.g., via forklift, cart, dolly, handtruck, conveyor belt, manually, or otherwise.

Hub zone 213 may be an area of FC 200 that receives all boxes or bags (“packages”) from packing zone 211. Workers and/or machines in hub zone 213 may retrieve package 218 and determine which portion of a delivery area each package is intended to go to, and route the package to an appropriate camp zone 215. For example, if the delivery area has two smaller sub-areas, packages will go to one of two camp zones 215. In some embodiments, a worker or machine may scan a package (e.g., using one of devices 119A-119C) to determine its eventual destination. Routing the package to camp zone 215 may comprise, for example, determining a portion of a geographical area that the package is destined for (e.g., based on a postal code) and determining a camp zone 215 associated with the portion of the geographical area.

Camp zone 215, in some embodiments, may comprise one or more buildings, one or more physical spaces, or one or more areas, where packages are received from hub zone 213 for sorting into routes and/or sub-routes. In some embodiments, camp zone 215 is physically separate from FC 200 while in other embodiments camp zone 215 may form a part of FC 200.

Workers and/or machines in camp zone 215 may determine which route and/or sub-route a package 220 should be associated with, for example, based on a comparison of the destination to an existing route and/or sub-route, a calculation of workload for each route and/or sub-route, the time of day, a shipping method, the cost to ship the package 220, a PDD associated with the items in package 220, or the like. In some embodiments, a worker or machine may scan a package (e.g., using one of devices 119A-119C) to determine its eventual destination. Once package 220 is assigned to a particular route and/or sub-route, a worker and/or machine may move package 220 to be shipped. In exemplary FIG. 2, camp zone 215 includes a truck 222, a car 226, and delivery workers 224A and 224B. In some embodiments, truck 222 may be driven by delivery worker 224A, where delivery worker 224A is a full-time employee that delivers packages for FC 200 and truck 222 is owned, leased, or operated by the same company that owns, leases, or operates FC 200. In some embodiments, car 226 may be driven by delivery worker 224B, where delivery worker 224B is a “flex” or occasional worker that is delivering on an as-needed basis (e.g., seasonally). Car 226 may be owned, leased, or operated by delivery worker 224B.

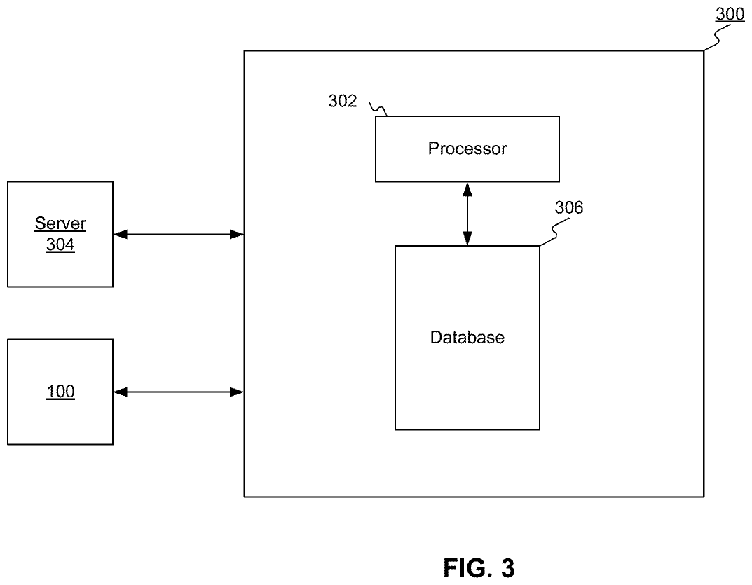

FIG. 3 is a block diagram illustrating an exemplary system 300 for predicting an optimal stop point during an experiment test, consistent with the disclosed embodiments. System 300 may include one or more processors 302 (referred to herein as processor 302) configured to determine an optimal stop point during an active A/B test or design of experiment test conducted on system 100. The active A/B test or design of experiment test may be conducted on External Front End System 103 where customers may interact with a webpage or a mobile application. Data regarding the active A/B test or design of experiment test may be recorded on server 304. Server 304 may acquire the data from Internal Front End System 105. The data may include the MDE data, the p-values, the sample sizes, additional analysis of variance (ANOVA) data, and the MDE trend data. The MDE data may represent, for example, a relative minimum improvement one seeks to detect over a change of a baseline webpage. The P-values may represent evidence that either supports or rejects a null hypothesis (i.e., a claim is assumed valid if its counterclaim is improbable) where P-values may quantify the idea of statistical significance of evidence. The sample sizes may represent the number of observations (i.e., customers liking a certain feature on a website) to include in a statistical sample. The ANOVA data may represent the collection of statistical models and their associated estimation procedures used to analyze the differences among group means in a sample. The MDE trend data may include, in some embodiments, both the observed MDE data up to now and the predicted MDE data over the future days up to the maximum days that the order fulfillment company may like to invest in the active A/B test or design of experiment test. A total test time may also be the future days up to the maximum days that the order fulfillment company may like to invest in the active A/B test or design of experiment test. The optimal stop point time is less than the total test time. Processor 302 may communicate the optimal stop point to server 304 to conclude the active A/B test or design of experiment test before the total test time has expired. Processor 302 may store the MDE trend data, the total test time, and the optimal stop point time in database 306.

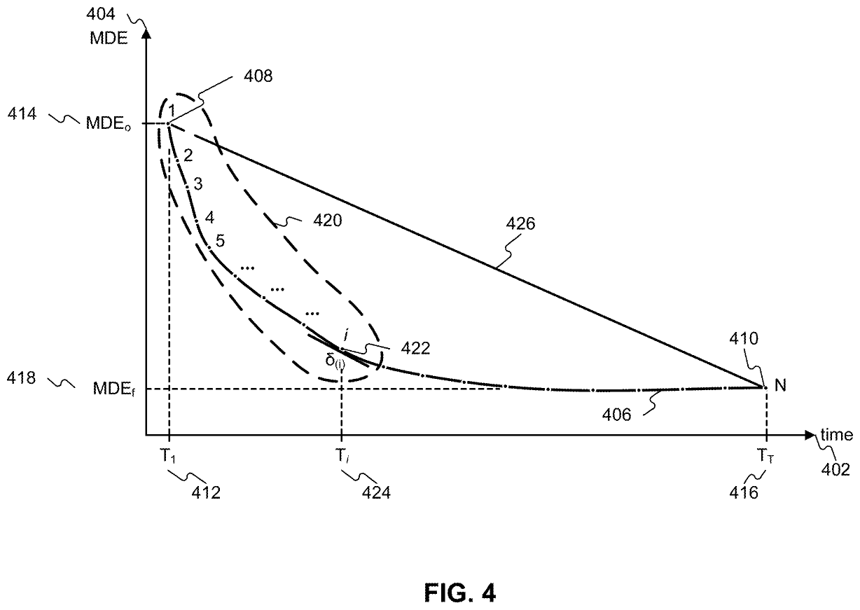

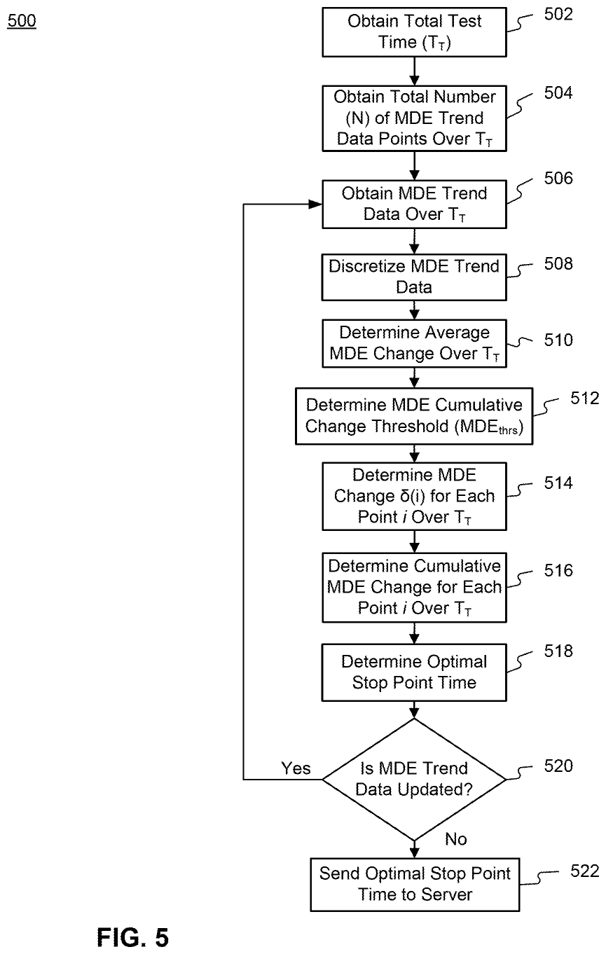

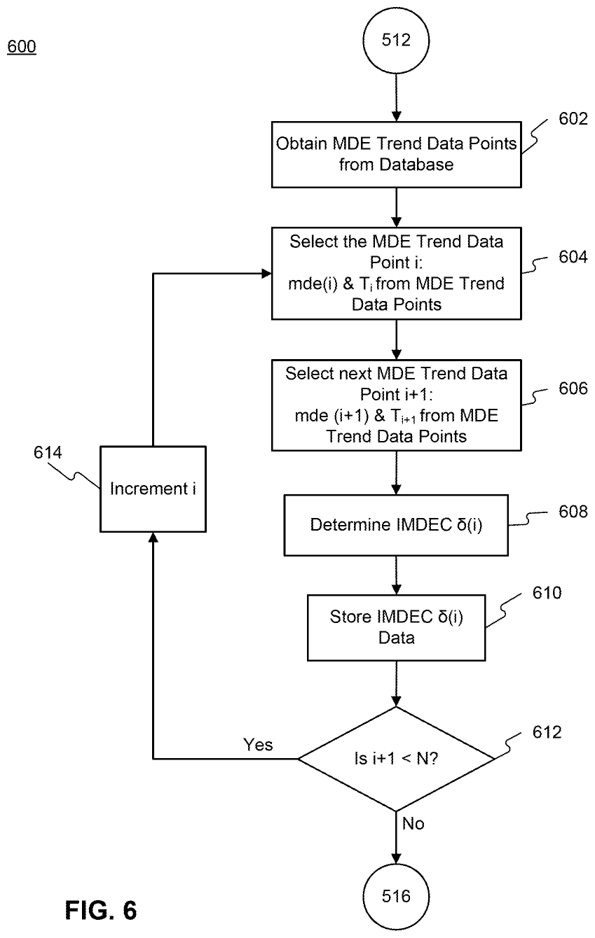

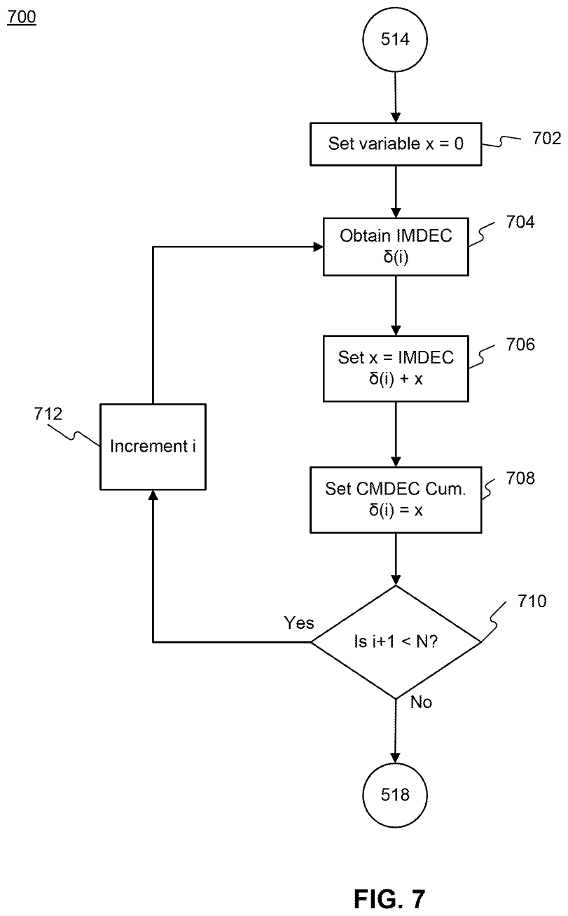

FIG. 4 depicts an exemplary chart illustrating a minimum detectable effect trend data curve and an average minimum detectable effect change, consistent with the disclosed embodiments. FIG. 4 is a representative illustration of the data that system 300 may retrieve and generate with processor 302 and database 306 to determine the optimal stop point time. The horizontal axis 402 may represent time, and the vertical axis 404 may represent the MDE trend data. Processor 302 may retrieve MDE trend data from server 304. The MDE trend data may include predicted MDE data over a total test time for which the active A/B test or design of experiment test is expected to run. The predicted MDE data over a total test time may be generated based on interpolation and/or extrapolation techniques and knowledge from previously completed A/B tests or design of experiment tests and the observed MDE data from the current test. The MDE trend data may be illustrated as MDE trend data curve 406 over a total test time for which the active A/B test or design of experiment test is expected to run. MDE trend data curve 406 may have a first data point 408 (1) and a final data point 410 (N). The first data point 408 (1) of MDE trend data curve 406 may have an initial time 412 at T₁ and its corresponding initial MDE 414 at MDE₀. Furthermore, the final data point 410 (N) may have a final time 416 at T_{T} and its corresponding final MDE 418 at MDE_{f}. Final time 416 at T_{T} may be the total test time. Processor 302 may generate MDE trend data points 420 based on the MDE trend data from 2 to i all the way to N-1 based on the first data point 408 (1) and the final data point 410 (N). Processor 302 may also utilize the MDE trend data itself from 1 to i all the way to the final data point 410 (N). N may be a total number of MDE trend data points or points in MDE trend data from which processor 302 may generate MDE trend data curve 406. For example, an instantaneous minimum detectable effect change (referred herein as IMDEC)—δ(i)—may be determined by processor 302 for each MDE trend data point i in 420 where all the IMDEC is a plurality of IMDECs. IMDEC may be the instantaneous slope based on MDE trend data or an infinitesimal change in MDE trend data. FIG. 6 below provides exemplary processes to determine IMDEC. Furthermore, time Tᵢ 424 may represent an optimal stop point time. In addition, a cumulative minimum detectable effect change (referred herein as CMDEC) may be determined by processor 302 for each MDE trend data point i in 420 based on aggregating the plurality of IMDECs. Thus, if the plurality of IMDECs have been evaluated from first data point 408 (1) to i, the CMDEC for i may be the sum of the plurality of IMDECs from first data point 408 (1) to i. FIG. 7 below provides exemplary processes to determine IMDEC. Furthermore, an average minimum detectable effect change (referred herein as AMDEC) 426 may be determined by processor 302 according to the first data point 408 (1) and the final data point 410 (N). FIG. 5 below provides exemplary processes to determine AMDEC. Processor 302 may store the total test time, the MDE trend data, the MDE trend data points i, which may include the first data point 408 (1) and the final data point 410 (N), the plurality of IMDECs, the plurality of CMDECs, and the AMDEC in database 306.

FIG. 5 is a flow chart of an exemplary method 500 of determining an optimal stop point time, consistent with the disclosed embodiments. The steps of method 500 may be performed by processor 302. At step 502, processor 302 may obtain the total test time from server 304 and store it in database 306. The total test time may be determined from an active A/B test or design of experiment test, past A/B test or design of experiment test, or MDE trend data from active or past A/B test or design of experiment on server 304. At step 504, processor 302 may obtain the total number (N) of MDE trend data points over the total test time from server 304 and store it in database 306. The total number (N) of MDE trend data points may represent even or uneven interval of times that processor 302 may utilize to determine the optimal stop point time. The interval of times may be seconds, minutes, hours, days, weeks, or months. At step 506, processor 302 may obtain the MDE trend data from server 304 and store the MDE trend data over the total test time in database 306. At step 508, if the MDE trend data has uneven intervals of times, processor 302 may discretize the MDE trend data to generate new MDE trend data points such that the time intervals between MDE trend data points may be uniform. The new MDE trend data points may replace old MDE trend data or existing MDE trend data points that may have uneven time intervals. The discretization process to generate the new MDE trend data points may be based on interpolation or extrapolation of the existing MDE trend data points. The discretization process may be performed over the total test time for the evaluation of the optimal stop point time. The new MDE trend data points may be stored by processor 302 in database 306. The MDE trend data points may be new (discretized) and/or existing MDE trend data points.

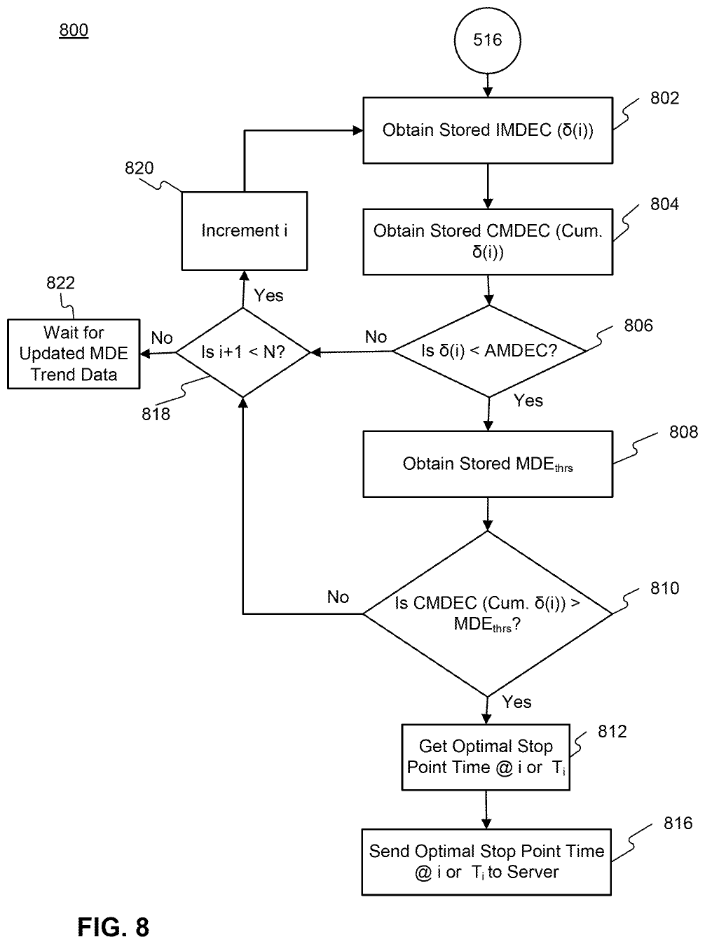

At step 510, processor 302 may determine the AMDEC over the total test time. The AMDEC may be a slope from the first data point 408 (1) and the final data point 410 (N) from the MDE trend data points. The AMDEC may be stored by processor 302 in database 306. At step 512, processor 302 may determine a MDE cumulative change threshold (MDEₜₕᵣₛ). The MDE cumulative change threshold may be a percentage of the difference between the initial MDE 414 and the final MDE 418 from the MDE trend data. The percentage difference between the initial MDE 414 and the final MDE 418 may range from 60 to 90 percent. The percentage may be based on the fulfillment company's research for a type of webpage. The MDE cumulative change threshold may be stored by processor 302 in database 306. At step 514, processor 302 may determine the plurality of IMDECs over the total test time based on the MDE trend data points from the MDE trend data. FIG. 6 below provides exemplary processes for determining the plurality of IMDECs. Processor 302 may store the plurality of IMDECs in database 306. The plurality of IMDECs may be the instantaneous slopes for each MDE trend data points from the MDE trend data. The plurality of IMDECs may also be the instantaneous difference between a MDE trend data point and a next MDE trend data point. The plurality of IMDECs may not be determined at the final data point 410 (N). At step 516, processor 302 may determine the plurality of CMDECs over the total test time based on the MDE trend data points from the MDE trend data. Processor 302 may store the plurality of CMDECs in database 306. The plurality of CMDECs may be the aggregation of each IMDEC up to data point i. The aggregation of each IMDEC may include the accumulation of each IMDEC for all data points (plurality of IMDECs) up to data point. The plurality of CMDECs may not be aggregated for the final data point 410 (N). At step 518, processor 302 may determine the optimal stop point time from the plurality of IMDECs, the plurality of CMDECs, and the MDE cumulative change threshold. FIG. 8 below provides exemplary processes for determining the optimal stop point time. The optimal stop point time may be stored in database 306 by processor 302.

At step 520, processor 302 may determine whether or not the MDE trend data in server 304 may have been updated based on the active A/B test or design of experiment test. Server 304 may provide a flag indicating whether the MDE trend data has been updated. Processor 302 may determine if the MDE trend data has been updated from the flag indication. If processor 302 determines that the MDE trend data has not been updated (step 520—no), then at step 522, processor 302 sends the optimal stop point time to server 304 so that the active A/B test or design of experiment test may be terminated or concluded at the optimal stop point time. However, if processor 302 determines that the MDE trend data has been updated (step 520—yes), then processor 302 repeats steps 506—steps 520. Updated MDE trend data is the MDE trend data that has been updated.

FIG. 6 is a flow chart of an exemplary method 600 of determining a plurality of instantaneous minimum detectable effect changes, consistent with the disclosed embodiments. The steps of method 600 may be performed by processor 302. The steps of method 600 depict an embodiment detailing steps to execute step 514. At step 602, processor may obtain the MDE trend data points over the total test time from the MDE trend data stored in database 306. At step 604, processor 302 may select the MDE trend data point i from the MDE trend data points, which has a MDE at i and a time (Tᵢ) at i. At step 606, processor 302 may select the next MDE trend data point i+1 from the MDE trend data points, which has a MDE at i+1 and a time (Tᵢ₊₁) i+1. At step 608, processor 302 may determine a IMDEC or δ(i) at the time Tᵢ based on the MDE trend data point i and the next MDE trend data point i+1. At step 610, processor 302 may store the IMDEC at the time Tᵢ in database 306. The IMDEC may be the difference of the MDE at i and the MDE at i+1 or the instantaneous slope at i between the MDE trend data point i and the next MDE trend data point 1+1.

At step 612, processor 302 may determine whether or not i+1 is less than the total number of MDE trend data points (N). Processor 302 may have obtained the total number of MDE trend data points (N) from database 306 or from the MDE trend data points. When processor 302 determines that i+1 is less than the total number of MDE trend data points (step 612—yes), then at step 614, processor 302 may increment i where i is increased by one unit. Processor 302 may repeat steps 604—steps 612 since the condition i+1 is less than the total number of MDE trend data points (N). However, when processor 302 determines that i+1 for the next MDE trend data point is equal to the total number of MDE trend data points (step 612—no), then processor 302 may proceed to step 516. The IMDEC or δ(i) at each time Tᵢ in database 306 is the plurality of IMDECs.

FIG. 7 is a flow chart of an exemplary method 700 of determining a plurality of cumulative minimum detectable changes, consistent with the disclosed embodiments. The steps of method 700 may be performed by processor 302. The steps of method 700 depict an embodiment detailing steps to execute step 516. At step 702, processor 302 may set a variable x equal to zero and store it into database 306. At step 704, processor 302 may obtain the IMDEC δ(i) at the time Tᵢ in database 306. At step 706, processor 302 may assign a new value for the variable x by adding variable x to the IMDEC or δ(i) at the time Tᵢ, which may be stored in database 306. At step 708, processor 302 may set a CMDEC or Cum. δ(i) at the time Tᵢ equal to variable x. Processor 302 may store CMDEC or Cum. δ(i) at the time Tᵢ in database 306.

At step 710, processor 302 may determine whether or not 1+1 is less than the total number of MDE trend data points (N). Processor 302 may have obtained the total number of MDE trend data points (N) from database 306 or from the MDE trend data points. When processor 302 determines that i+1 is less than the total number of MDE trend data points (N) (step 710—yes), then at step 712, processor 302 may increment i where i is increased by one unit. Processor 302 may repeat steps 704—steps 710 since the condition i+1 is less than the total number of MDE trend data points (N). However, when processor 302 determines that i+1 for the next MDE trend data point is equal to the total number of MDE trend data points (N) (step 710—no), then processor 302 may proceed to step 518. The CMDEC or Cum. δ(i) at each time Tᵢ in database 306 is the plurality of CMDECs.

FIG. 8 is a flow chart of an exemplary method 800 of determining and providing an optimal stop point time to a server to stop an active A/B test or design of experiment test, consistent with the disclosed embodiments. The steps of method 800 may be performed by processor 302. The steps of method 800 depict an embodiment detailing steps to execute step 518. At step 802, processor 302 may obtain the IMDEC or δ(i) at the time Tᵢ from database 306. At step 804, processor 302 may obtain the CMDEC or Cum. δ(i) at the time Tᵢ from database 306. At step 806, processor 302 may obtain the AMDEC from database 306 and may determine whether or not the IMDEC or δ(i) at the time Tᵢ is less than the AMDEC. When processor 302 determines that the IMDEC or δ(i) at the time Tᵢ is less than the AMDEC (step 806—yes), then at step 808, processor 302 may obtain the MDE cumulative change threshold from database 306. At step 810, processor 302 may determine whether or not the CMDEC or Cum. δ(i) at the time Tᵢ is greater than the MDE cumulative change threshold. When processor 302 determines that the CMDEC or Cum. δ(i) at the time Tᵢ is greater than the MDE cumulative change threshold, then at step 812, processor 302 may get the optimal stop point time from Tᵢ, which may correspond to the same time where IMDEC or δ(i) is less than AMDEC, and CMDEC or Cum. δ(i) is greater than the MDE cumulative change threshold. At step 816, processor 302 may store the optimal stop point time Tᵢ in database 306 and send the optimal stop point time Tᵢ to server 304 for the active A/B test or design of experiment test to stop, terminate, or conclude at the optimal stop point time Tᵢ.

However, when processor 302 determines that the IMDEC or δ(i) at the time Tᵢ is equal or greater than the AMDEC (step 806—no), or the CMDEC or Cum. δ(i) at the time Tᵢ is less or equal to the MDE cumulative change threshold, then at step 818, processor 302 may determine whether or not i+1 is less than the total number of MDE trend data points (N). Processor 302 may have obtained the total number of MDE trend data points (N) from database 306 or from the MDE trend data points.. When processor 302 determines that i+1 is less than the total number of MDE trend data points (step 818—yes), then at step 820, processor 302 may increment i where i is increased by one unit. Processor 302 may repeat steps 802—steps 806 or steps 802—steps 810 since the condition i+1 is less than the total number of MDE trend data points (N). However, when processor 302 determines that i+1 is equal to the total number of MDE trend data points (N) (step 818—no), then at step 822, processor 302 may wait for the updated MDE trend data from server 304.

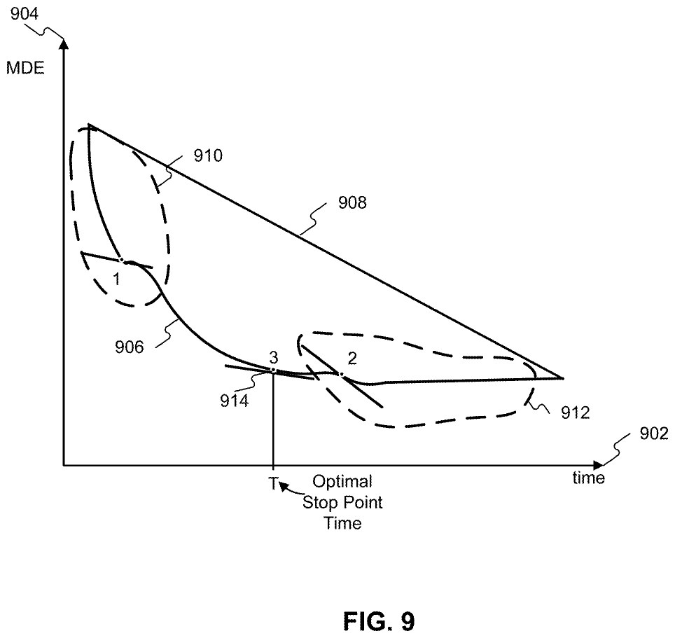

FIG. 9 depicts sample optimal stop time determination conditions, consistent with the disclosed embodiments. FIG. 9 will help describe different conditions for a given use case in determining the optimal stop point. For example, an A/B test on a webpage of the order fulfillment company may be set to run for 21 days where customers' reactions in regards to sales of a product is tracked through two variations of element of the webpage. Consider an exemplary situation where the A/B test on the webpage may have been running for the past 5 days, and data on the variations of the webpage may be collected on a daily basis.

The horizontal axis 902 may represent time in terms of days, and the vertical axis 804 may represent MDE data 904 being tracked on a daily basis. Based on the data collected from the A/B test for the past 5 days on server 304, an MDE trend data 906 may be generated from day 1 to day 21 given that the A/B test may be scheduled to run for a total of 21 days. Therefore, the MDE trend data curve 906 may have a total of 21 data points with increments of 1 day. Processor 302 may determine an AMDEC 908 based on the data from day 1 and day 21. Furthermore, processor 302 may determine at condition 1 in 910 an IMDEC₁, which is less than the AMDEC 908. In addition, processor 302 may determine that at condition 1 in 910 a CMDEC₁ is less than, for example, 88% of the difference in MDE from day 1 and day 21—MDE cumulative change threshold. Therefore, processor 302 may not find condition 1 to be the optimal stop point time because the required two conditions to predict an optimal stop point time are not met, which are that the IMDEC₁ must be less than the AMDEC 908, and the CMDEC1 must be greater than, for example, 88% of the difference in MDE from day 1 and day 21—MDE cumulative change threshold. Similarly, at condition 2 in 912, processor 302 may determine that a IMDEC₂ is greater than the AMDEC 908 although a CMDEC₂ is greater than, for example, 88% of the difference in MDE from day 1 and day 21. Again, processor 302 may not find that condition 2 to be the optimal stop point time because the required two conditions to predict an optimal stop point time are not met, which are that the IMDEC₂ must be less than the AMDEC 908, and the CMDEC₂ must be greater than, for example, 88% of the difference in MDE from day 1 and day 21—MDE cumulative change threshold. At condition 3 914, processor 302 may determine that the IMDEC₃ to be less than the AMDEC 908, and the CMDEC₃ to be greater than, for example, 88% of the difference in MDE from day 1 and day 21—MDE cumulative change threshold; therefore, processor 302 would extract optimal stop point time (T) at condition 3 914 and send it to server 304. The optimal stop point time (T) may be day 15; therefore the A/B test on day 15 would be terminated given that the optimal stop point time was determined by processor 302. This would allow the order fulfillment company to not invest unnecessary resources in conducting an A/B test for 20 days since 15 days may be enough to reach the determination that the A/B test may have provided enough sample size (test power) in terms of detecting the decrease in MDE and the marginal benefit to know if running more than 15 days would not be worth it.

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

1. A computer-implemented system for predicting an optimal stop point during an experiment test, the system comprising:
a memory storing instructions; and
at least one or more processors configured to execute the instructions to perform steps comprising:
obtaining a total test time for a test on a webpage on a server, wherein the test is an active test on the webpage on the server and the webpage comprises at least one interaction with an interface element of the webpage from at least one user device;
obtaining a minimum detectable effect trend data over the total test time from the test on the server based on the at least one interaction from the at least one user device;
determining an average minimum detectable effect change over the total test time associated with the minimum detectable effect trend data;
determining a minimum detectable effect cumulative change threshold over the total test time associated with the minimum detectable effect trend data;
determining a plurality of instantaneous minimum detectable effect changes over the total test time associated with the minimum detectable effect trend data;
determining a plurality of cumulative minimum detectable effect changes associated with the plurality of instantaneous minimum detectable effect;
determining an optimal stop point time based on the average minimum detectable effect change, the plurality of instantaneous minimum detectable effect changes, and the minimum detectable effect cumulative change threshold; and
concluding the test at the optimal stop point time by terminating the active test on the webpage on the server.

2. The system of claim 1, wherein the at least one or more processors are further configured to perform steps comprising:
obtaining a total number of MDE trend data points from the server;
wherein the minimum detectable effect trend data is discretized by the total number of MDE trend data points.

3. The system of claim 1, wherein the average minimum detectable effect change is a slope over the total test time; and wherein the minimum detectable effect cumulative change threshold is a percentage of a difference in minimum detectable effect over the total test time.

4. The system of claim 1, wherein the plurality of instantaneous minimum detectable effect changes are a plurality of instantaneous slopes of the minimum detectable trend data.

5. The system of claim 1, wherein the at least one or more processors are further configured to perform steps comprising:
obtaining a total number of MDE trend data points from the server;
wherein the plurality of instantaneous minimum detectable effect changes are evaluated at each the total number of MDE trend data points.

6. The system of claim 1, wherein the plurality of cumulative minimum detectable effect changes are the aggregation of the plurality of instantaneous minimum detectable effect changes.

7. The system of claim 1, wherein the at least one or more processors are further configured to perform steps comprising:
obtaining a total number of MDE trend data points from the server;
wherein the plurality of cumulative detectable effect changes are evaluated at each the total number of MDE trend data points.

8. The system of claim 1, wherein the at least one or more processors are further configured to perform steps comprising:
storing the total test time, the minimum detectable effect cumulative change threshold, the minimum detectable effect trend data, the average minimum detectable effect change, the plurality of instantaneous minimum detectable effect changes, the plurality of cumulative minimum detectable effect changes, and the optimal stop point time in a database.

9. The system of claim 8, wherein the optimal stop point time is determined when an instantaneous minimum detectable effect change associated with the optimal stop point time from the database is less than the average minimum detectable effect change, and a cumulative detectable effect change with the optimal stop point time from the database is greater than the minimum detectable effect cumulative change threshold.

10. The system of claim 1, further configured for the at least one or more processor to perform the steps comprising:
detecting an updated minimum detectable effect trend data on the server;
wherein the optimal stop point time is determined based on the updated minimum detectable effect trend data from the test.

11. A computer-implemented method for predicting an optimal stop point during an experiment test:
obtaining a total test time for a test on a webpage on a server, wherein the test is an active test on the webpage on the server and the webpage comprises at least one interaction with an interface element of the webpage from at least one user device;
obtaining a minimum detectable effect trend data over the total test time from the test on the server based on the at least one interaction from the at least one user device;
determining an average minimum detectable effect change over the total test time associated with the minimum detectable effect trend data;
determining a minimum detectable effect cumulative change threshold over the total test time associated with the minimum detectable effect trend data;
determining a plurality of instantaneous minimum detectable effect changes over the total test time associated with the minimum detectable effect trend data;
determining a plurality of cumulative minimum detectable effect changes associated with the plurality of instantaneous minimum detectable effect;
determining an optimal stop point time based on the average minimum detectable effect change, the plurality of instantaneous minimum detectable effect changes, and the minimum detectable effect cumulative change threshold; and
concluding the test at the optimal stop point time by terminating the active test on the webpage on the server.

12. The method of claim 1, further the method comprising:
obtaining a total number of MDE trend data points from the server;
wherein the minimum detectable effect trend data is discretized by the total number of MDE trend data points.

13. The method of claim 1, wherein the average minimum detectable effect change is a slope over the total test time; and wherein the minimum detectable effect cumulative change threshold is a percentage of a difference in minimum detectable effect over the total test time..

14. The method of claim 1, wherein the plurality of instantaneous minimum detectable effect changes are a plurality of instantaneous slopes of the minimum detectable trend data.

15. The method of claim 1, further the method comprising:
obtaining a total number of MDE trend data points from the server;
wherein the plurality of instantaneous minimum detectable effect changes are evaluated at each the total number of MDE trend data points.

16. The method of claim 1, wherein the plurality of cumulative minimum detectable effect changes are the aggregation of the plurality of instantaneous minimum detectable effect changes.

17. The method of claim 1, further the method comprising:
obtaining a total number of MDE trend data points from the server;
wherein the plurality of cumulative detectable effect changes are evaluated at each the total number of MDE trend data points.

18. The method of claim 1, further the method comprising:
storing the total test time, the minimum detectable effect cumulative change threshold, the minimum detectable effect trend data, the average minimum detectable effect change, the plurality of instantaneous minimum detectable effect changes, the plurality of cumulative minimum detectable effect changes, and the optimal stop point time in a database.

19. The method of claim 8, wherein the optimal stop point time is determined when an instantaneous minimum detectable effect change associated with the optimal stop point time from the database is less than the average minimum detectable effect change, and a cumulative detectable effect change associated with the optimal stop point time from the database is greater than the minimum detectable effect cumulative change threshold.

20. A computer-implemented system for predicting an optimal stop point during an experiment test, the system comprising:
a memory storing instructions; and
at least one or more processors configured to execute the instructions to perform steps comprising:
obtaining a total test time for a test on a webpage on a server, wherein the test is an active test on the webpage on the server and the webpage comprises at least one interaction with an interface element of the webpage from at least one user device;
obtaining a minimum detectable effect trend data over the total test time from the test on the server based on the at least one interaction from the at least one user device;
determining an average minimum detectable effect change over the total test time associated with the minimum detectable effect trend data;
determining a minimum detectable effect cumulative change threshold over the total test time associated with the minimum detectable effect trend data;
determining a plurality of instantaneous minimum detectable effect changes over the total test time associated with the minimum detectable effect trend data;
determining a plurality of cumulative minimum detectable effect changes associated with the plurality of instantaneous minimum detectable effect;
storing the total test time, the minimum detectable effect cumulative change threshold, the minimum detectable effect trend data, the average minimum detectable effect change, the plurality of instantaneous minimum detectable effect changes, the plurality of cumulative minimum detectable effect changes, and the optimal stop point time in a database;
receiving updated minimum detectable effect trend data when an instantaneous minimum detectable effect change is greater than or equal to the average minimum detectable effect change;
determining an optimal stop point time when an instantaneous minimum detectable effect change associated with the optimal stop point time from the database is less than the average minimum detectable effect change, and a cumulative detectable effect change associated with the optimal stop point time from the database is greater than the minimum detectable effect cumulative change threshold; and
concluding the test at the optimal stop point time, by terminating the active test on the webpage on the server.
